(19) United States
(12) Patent Application Publication
(10) Pub. No.: US 2012/0019017 A1
(43) Pub. Date: Jan. 26, 2012

(54) Multi-configuration Plant Pot Holder and Handle

(75) Inventor: Eugene E. Leptien, Marathon, WI (US)

(73) Assignee: ISM INDUSTRIES LLC, Marathon, WI (US)

(21) Appl. No.: 13/187,314

(22) Filed: Jul. 20, 2011

Related U.S. Application Data
(60) Provisional application No. 61/366,369, filed on Jul. 21, 2010.

(51) Int. Cl. B25J 15/08; B66F 19/00

(52) U.S. Cl. 294/175; 294/209; 294/210; 294/204

(57) ABSTRACT

The present invention directed to an apparatus for holding at least one plant, and preferably multiple pots having plants, typically 5 to 8 inches in diameter, which may need to be transported such as at a nursery, or loaded onto a semitrailer for transport. The apparatus allows a user to easily pick up and hold the pots with little strain on the hands and wrists, and without needing to bend over to pick them up off the ground.

### CROSS REFERENCE TO RELATED APPLICATIONS

This application claims priority from U.S. provisional application No. 61/366,369 filed 21 Jul. 2010; entitled “Multi-configuration plant handle and holder”. The entire contents being hereby incorporated by reference and for which benefit of the priority date is claimed.

### FIELD OF THE INVENTION

The present invention relates to a tool comprising a holder and handle for transporting plants in plastic pots and the like and, more particularly, to a multi configuration plant holder with means to multiple planters or porting such as at a nursery or loading a truck for easier transport.

### BACKGROUND OF THE INVENTION

Plastic containers, also known as planters, in which ornamental plants are grown in a greenhouse have been known for some time in the prior art. These are also referred to as plant pots and are typically formed of stamped or molded plastic. Typically, the design of the container which holds the plant includes a rim being defined as a projection, folding, or jutting at or near the top of the container intended structurally as a stiffener to keep the container from collapsing or the container wall from ripping apart. The rim can be formed to project or extend outward from the container wall, or inward from the container wall.

When moving a multiple of such containers, such as loading a landscaping truck, transport truck such as a semi truck trailer, or at a nursery, typically each container has to be grabbed and moved individually, which is labor intensive and time consuming.

### SUMMARY OF THE INVENTION

In accordance with the present invention, there is provided a tool for transporting potted plants with multiple ledges and having capability to interface with a pot having an inwardly directed rim, or a pot having an outwardly directed rim to pick up the plant and transport it from one location to another.

It is therefore an object of the invention to provide a tool for transporting potted plants having a face to stabilize the pots.

It is therefore an object of the invention to allow the transport of multiple pots associated with one handle.

It is another object of the invention to provide an active latch mechanism for holding multiple pots of either inwardly or outwardly directed rim orientations.

### BRIEF DESCRIPTION OF THE DRAWINGS

A complete understanding of the present invention may be obtained by reference to the accompanying drawings, when considered in conjunction with the subsequent, detailed description, in which:

FIG. 1 depicts a front perspective view of a plant handle of one embodiment of the present invention;

FIGS. 2A, 2B, depict perspective views showing part of a plant pot holder engaging with an outwardly directed plant container rim;

FIG. 2C, depicts a perspective view showing part of a plant pot holder engaging with an inwardly directed plant container rim;

FIG. 3 depicts a side view an alternate embodiment of a plant pot holder having two container holders being on opposite ends of an extension member;

FIGS. 4A and 4B depict a partial through section view of a third alternate embodiment of a plant container holder having two plant container holders hanging from each of two bifurcated extension members;

FIG. 5 depicts a front view of a handle and vertical member with a holding apparatus;

FIG. 6 depicts a rear view of a handle and vertical member with a holding apparatus;

FIG. 7 depicts a front perspective view of a forth alternate embodiment of a plant container holder comprising an active latch mechanism;

FIG. 8 depicts a rear perspective view of the embodiment of FIG. 7;

FIGS. 9A and 9B depict detail views of the pinching mechanism of the embodiment of FIG. 7 in release and gripping configurations respectively;

FIGS. 10 depicts rear perspective view of the embodiment of FIG. 7 holding a container having an inwardly directed pot rim and an outwardly directed pot rim.

### DETAILED DESCRIPTION

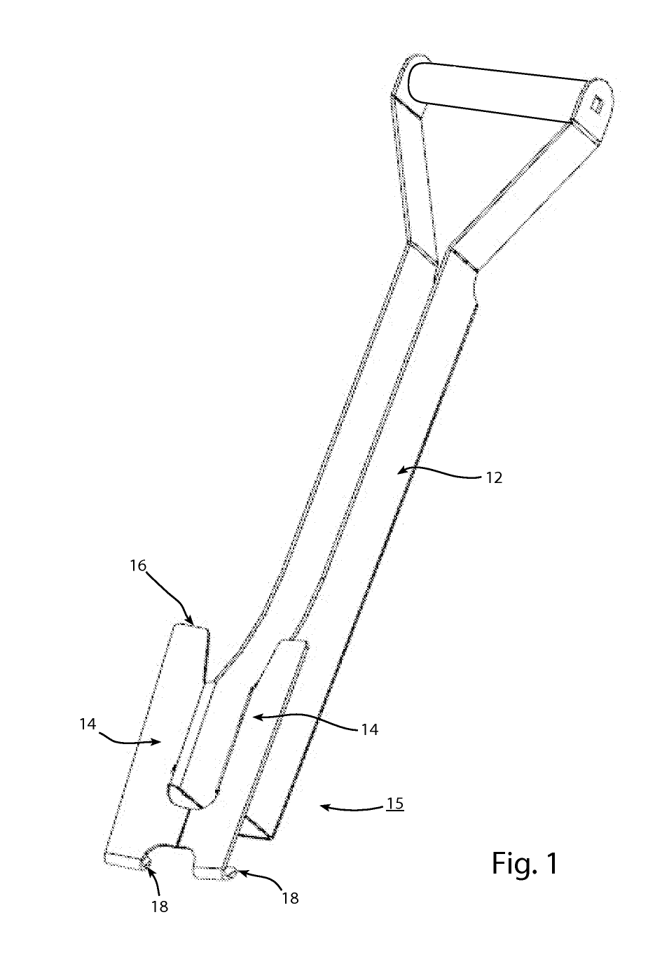

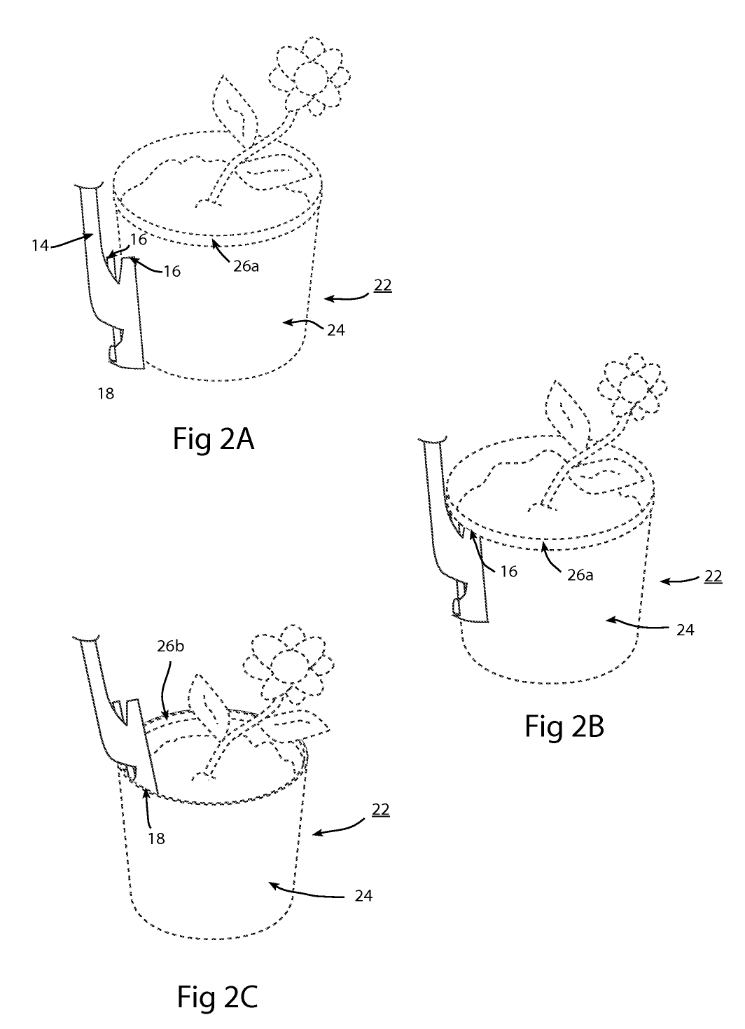

A first embodiment, as shown in FIGS. 1-2, show a tool and an example of use for the present invention for picking up a potted plant container or planter (22) by means of the planter rim (26). The apparatus, generally formed of light grade stamped steel and anodized or painted, comprising a handle member (10) being connected with a vertical extender (12), the vertical extender (12) can be adapted with a telescoping mechanism such as is common in the art and not shown, and having a holding apparatus (15) located distally from the handle (10).

The holding apparatus further comprising at least one ledge (16) for supporting an outwardly directed container rim (26a). The ledge can also be in connection with a face (14), with the face (14) being brought into contact with planter side wall (24) for stabilization of the planter (22). A typical operation comprising hooking the shelf (16) under the planter rim (26) and lifting.

A holding apparatus (15) further comprises a second ledge (18) or shoulder which in this case is a formed be bending or re-curving the bottom portion of the face (14). In this case the second ledge (18) forms a cleat or projection serving as a support or check to help keep the container (22) from sliding off the ledge (18).

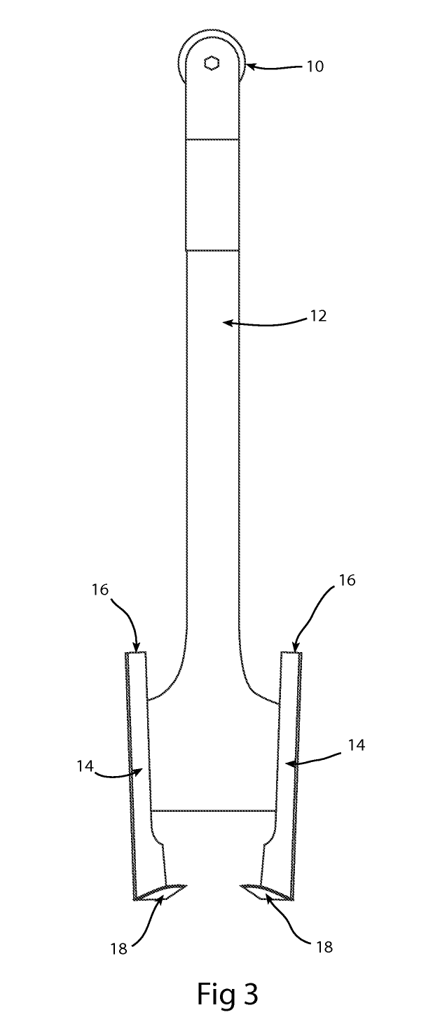

As an alternate embodiment, the handle (12) as shown in FIG. 3, multiple ledges (16) (18) can be formed from the same vertical extension (12) thus increasing carrying capacity.

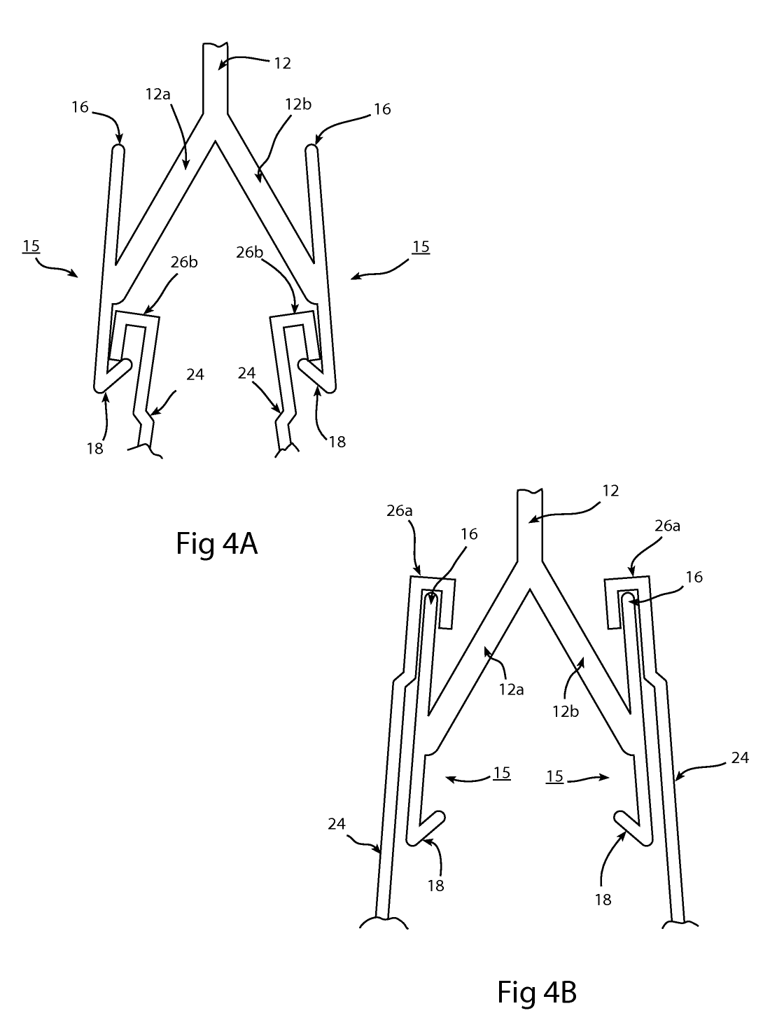

In FIGS. 4A the vertical extension can be split, branched, or bifurcated into alternate extensions (12a) (12b) each associated with a separate holding apparatus (15) for holding multiple containers (22). In the current instance of FIG. 4, the bifurcations are situated to allow multiple pots having either an inwardly directed rim (26b) extending into a planter wall (24) with an overhang (28) suited to receive a shoulder or ledge (18). In this instance the planter side wall (24) is allowed to hang below the holding apparatus (15) which can correct to a stable position via gravity.

A further configuration using the embodiment of FIG. 4 shown in 4B is also suited to carrying a multiple of planters (22) having an outwardly directed rim (26a). In this example, the outwardly directed rim (26a) with an overhang (28) is better directed toward resting on ledge (16) with the planter side wall (24) resting on the face (14) of the multiple holding apparatus' (15).

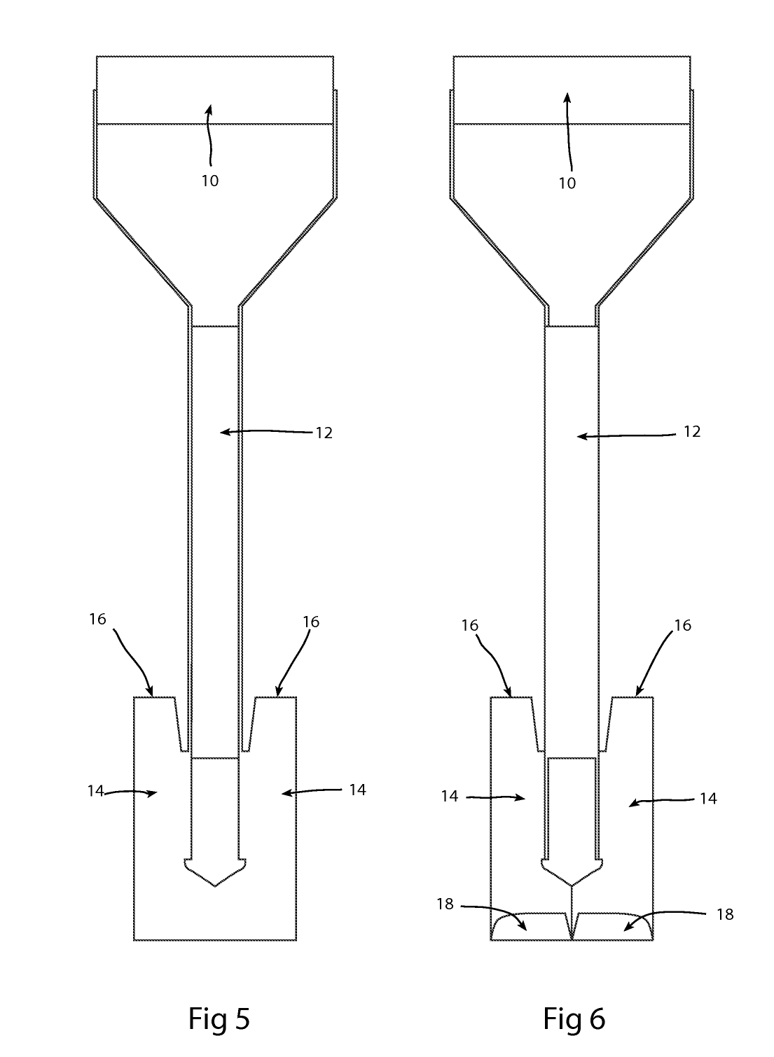

FIGS. 5 and 6 illustrate an embodiment of the invention shown in FIG. 1 which is currently preferred for manufacturing purposes being able to be cut and stamped out of a single piece of sheet metal. As those skilled in the art will appreciate, the elements and functions previously described can be transferred applied to the embodiments shown therein.

In an alternate use of the embodiments of FIGS. 5 and 6, two carriers can be used in parallel, preferably with the ledges (18) directed toward lifting a particularly large container (not shown) having a rim.

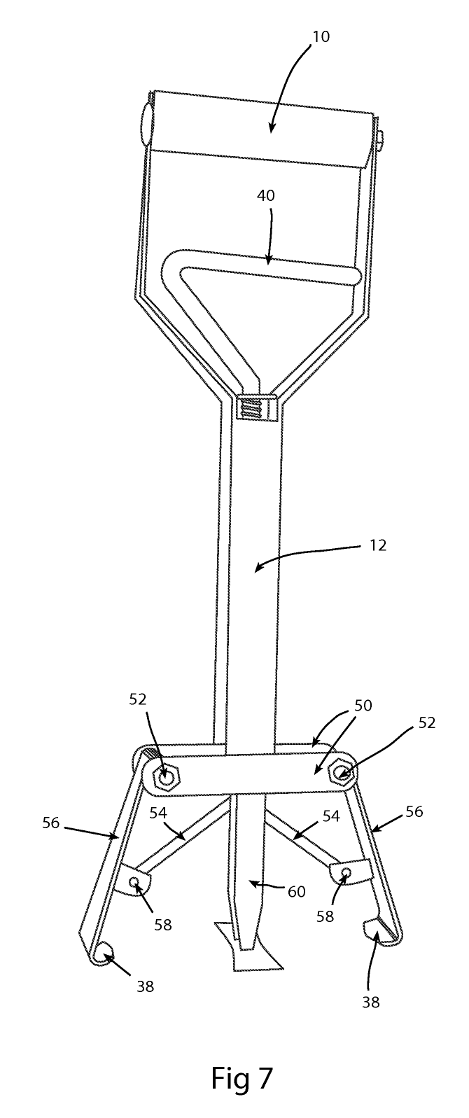

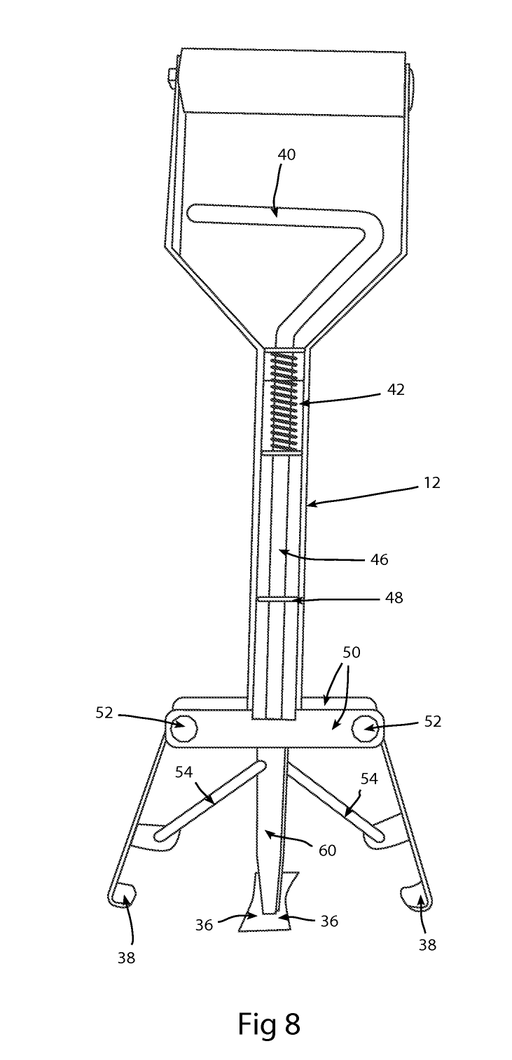

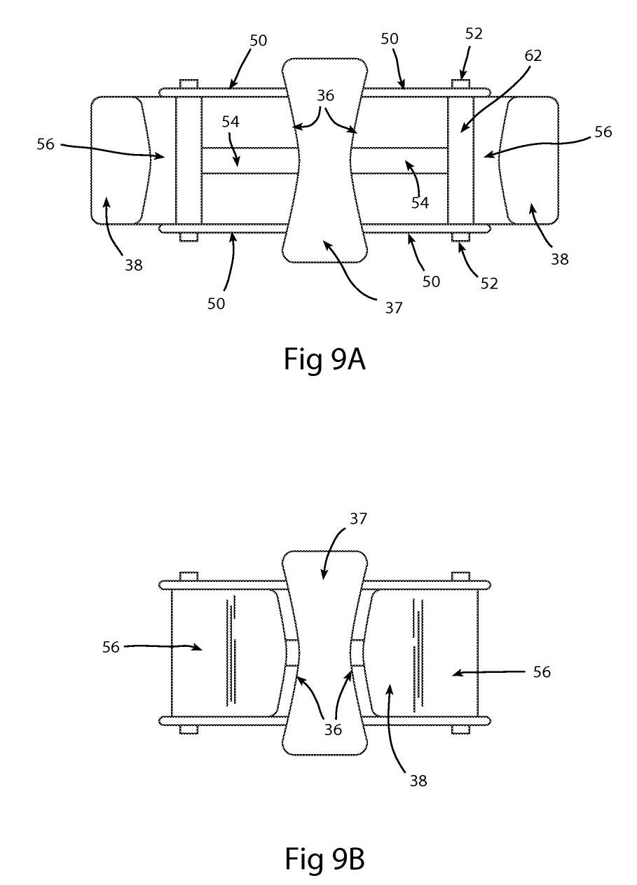

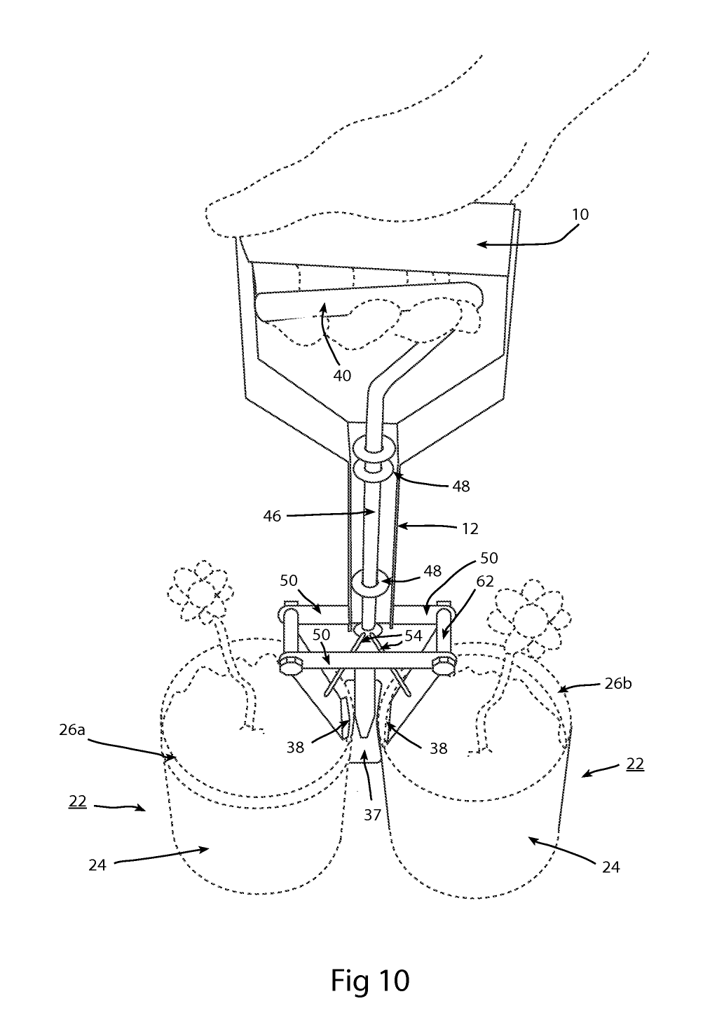

In yet another embodiment shown in FIGS. 7-10, and active latch mechanism is provided for bringing a multiple of separate first ledge(s) (36) for supporting an outwardly directed container rim (26a) into proximity with a multiple of separate second ledge(s) (38) for supporting an inwardly directed container rim (26b). As can be seen from FIG. 10 this embodiment is capable of supporting multiple configurations simultaneously, supporting an outwardly directed rim (26a) and in inwardly directed rim (26b) planter (22) at the same time.

The mechanism comprises a latch handle (40) disposed near the handle (10), optionally with a spring (42) for retracting the mechanism to the open position. A shaft (46) is disposed to the interior of the vertical extender (12) with series of guide bushings (48) for guiding and centering. Near the bottom of the vertical extender (12) at least one, and preferably two beams (50) are rigidly attached. The beams (50) interface with at least one pivot (52) and pivot pin (62) having a face (56) extending downwardly and in connection with at least one inwardly directed ledge (38). The face (56) also in operational connection with a coupling member directed to a connection with the shaft (46) such that when the latch handle (40) is pulled toward the handle (10) the inward ledges are rotated inwardly toward at least one outwardly directed ledge (36). A spacer (60) is provided to hold a shelf (37) having at least one ledge (36) associated therewith.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

Having thus described the invention, what is desired to be protected by Letters Patent is presented in the subsequent appended claims.

What is claimed is:

1. A multi-configuration carrier for potted plant containers with a handle and vertical extender having ergonomic utility, the carrier comprising:
(i) a vertical extender having a first end and a second end;
(ii) a handle member in connection with the first end of said vertical extender;
(iii) the second end of said vertical extender in working relationship with a multiple of holding ledges;
(iv) the multiple of holding ledges comprising at least one first ledge for supporting an outwardly directed container rim, and at least one second ledge for supporting an inwardly directed container rim.

2. The multi-configuration carrier for potted plants in accordance with claim 1 wherein the vertical extender is sufficiently long such that the worker has minimal bending to pick up a potted plant.

3. The multi-configuration carrier for potted plants in accordance with claim 2 wherein the vertical extender is adjustable in length.

4. The multi-configuration carrier for potted plants in accordance with claim 1 wherein the ledge further comprises a cleat.

5. The multi-configuration carrier for potted plants in accordance with claim 4 further comprising a face for stabilizing a potted plant container.

6. The multi-configuration carrier for potted plants in accordance with claim 5 having capacity to hold a multiplicity of potted plant containers by means of one handle.

7. The multi-configuration carrier for potted plants in accordance with claim 6 wherein the capacity to hold a multiplicity of pots includes a combination of outwardly directed pot rims and inwardly directed pot rims.

8. The multi-configuration carrier for potted plants in accordance with claim 1 further comprising an active latch mechanism.

9. The multi-configuration carrier for potted plants in accordance with claim 8 wherein the active latch mechanism includes a pinching mechanism activated near the handle member.

10. A multi-configuration potted plant container holder and handle for holding at least one potted plant container, the container having a rim, the holder comprising:
(i) a handle member in connection with a vertical member;
(ii) the vertical member in connection with at least one holding apparatus for holding at least one planter having a planter rim;
(iii) the holding apparatus comprising a ledge being suited for holding an outwardly directed container rim, and a ledge being suited for holding an inwardly directed container rim.

11. The multi-configuration plant holder and handle for holding at least one potted plant in accordance with claim 10 further comprising a face for stabilizing the container.

12. The multi-configuration plant holder and handle for holding at least one potted plant in accordance with claim 10 wherein at least one ledge further comprises a cleat for further holding either an inwardly or outwardly directed container rim.

13. The multi-configuration plant holder and handle for holding at least one potted plant in accordance with claim 12 wherein the vertical member is adjustable in length.

14. The multi-configuration plant holder and handle for holding at least one potted plant in accordance with claim 12 further comprising the vertical member being bifurcated into a plurality of vertical members, each said member comprising a holding apparatus, and each holding apparatus being coordinated to hold a plurality of containers.

15. The multi-configuration plant holder and handle for holding at least one potted plant in accordance with claim 14 wherein the number of bifurcated vertical members is three.

16. The multi-configuration plant holder and handle for holding at least one potted plant in accordance with claim

17. An ergonomic carrier for plant containers comprising:
(i) a vertical extender comprising a first end and a second end;
(ii) a handle member being attached to the first end of the vertical extender;
(iii) a grip being disposed near the handle, and being operationally connected with a series of ledges, the series of ledges comprising;
(iv) a first ledge adapted for interfacing with an outwardly directed container rim; and
(v) a second ledge adapted for interfacing with a inwardly directed container rim;
(vi) such that when the grip is activated, the first ledge and the second ledge come together to grip the rim of the container.

18. (canceled)
